(19) United States
(12) Patent Application Publication
(10) Pub. No.: US 2012/0162045 A1
(43) Pub. Date: Jun. 28, 2012

(54) PORTABLE TERMINAL

(75) Inventors: Yuki Miyamatsu, Tokyo (JP); Ken Suzuki, Kanagawa (JP)

(73) Assignee: Panasonic Corporation, Osaka (JP)

(21) Appl. No.: 13/393,708

(22) PCT Filed: Sep. 10, 2010
(86) PCT No.: PCT/IB2010/002745

§ 371 Date: Mar. 1, 2012

(30) Foreign Application Priority Data
Sep. 10, 2009 (JP) 2009-209741

(51) Int. Cl. H01Q 1/24

(52) U.S. Cl. 343/888

(57) ABSTRACT

A portable terminal includes a whip antenna, a housing that has an insertion hole for inserting the whip antenna, a printed circuit board that is disposed within the housing, the electrically conductive plate member that is abutted against the whip antenna, and the electrically conductive spring member that is arranged between the printed circuit board and the electrically conductive plate member. The whip antenna includes a slide part and a retention part. The electrically conductive plate member is positioned between the whip antenna and the electrically conductive spring member, and is pressed against the whip antenna at a second surface of the electrically conductive plate member opposite to a first surface of the electrically conductive plate member against which the electrically conductive spring member is pressed in a thickness direction of the housing.

### TECHNICAL FIELD

The present invention relates to a portable terminal having a whip antenna.

### BACKGROUND ART

As a conventional art, in an antenna device disclosed in Patent Literature 1, a feed line to an antenna is formed through a holder that holds the antenna and is fixed to a case, and a feed spring that is engaged with the holder. Since the feed spring straddles the holder so as to surround the holder for engagement, the feed spring can be prevented from dropping out and rotating. For that reason, the feed line to the line can be surely ensured.

### CITATION LIST

### Patent Literature

Patent Literature 1: JP-A-2000-151236

### SUMMARY OF INVENTION

### Technical Problem

However, in the above-described Patent Literature 1, a range in which the feed spring has a contact with the holder is limited to a part of the holder fixed to the case, and the range in which the feed spring has the contact with the holder cannot be sufficiently ensured.

An object of the present invention is to provide a portable terminal that enables an electrically conductive spring member to surely form a contact with the holder.

### Solution to Problem

According to the present invention, there is provided a portable terminal including a whip antenna; a housing that has an insertion hole through which the whip antenna is inserted; a printed circuit board that is disposed within the housing; an electrically conductive plate member that is abutted against the whip antenna within the housing; and an electrically conductive spring member that is arranged between the printed circuit board and the electrically conductive plate member, in which the whip antenna includes a slide part that is slidable within the housing, and a retention part that slidably retains the slide part, a pair of first ribs is provided along a slide direction of the slide part so as to retain the retention part of the whip antenna therebetween within the housing, a second rib is provided between the pair of first ribs on an opposite side of the electrically conductive spring member across the whip antenna, and supports the retention part, and the electrically conductive plate member is positioned between the whip antenna and the electrically conductive spring member within the housing, and is pressed against the whip antenna at a second surface of the electrically conductive plate member opposite to a first surface of the electrically conductive plate member against which the electrically conductive spring member is pressed in a thickness direction of the housing.

According to the above configuration, the electrically conductive spring member can surely form the contact with the electrically conductive plate member.

In the portable terminal, the pair of first ribs supports the electrically conductive plate member by bringing a part of a surface facing the electrically conductive plate member into contact with the first surface of the electrically conductive plate member.

According to the above configuration, since the electrically conductive plate member is surely fixed by the pair of first ribs, the electrically conductive spring member can surely form the contact with the electrically conductive plate member.

In the portable terminal, a surface of the second rib for supporting the retention part is formed in a curved surface.

According to the above configuration, the antenna can be easily positioned by the second rib, and the electrically conductive plate member can surely contact the antenna.

Also, the electrically conductive plate member has a wide part which brings into contact with the pair of first ribs and a narrow part which is smaller in width than the wide part, at a surface of the electrically conductive plate member with which the electrically conductive spring member is contacted.

Also, the electrically conductive plate member is formed in a U shape in a cross section thereof, and is contained between the pair of the first ribs while contacting the pair of the first ribs.

### Advantageous Effects of Invention

According to the cellular phone of the present invention, the electrically conductive plate member can surely form the contact with the electrically conductive plate member.

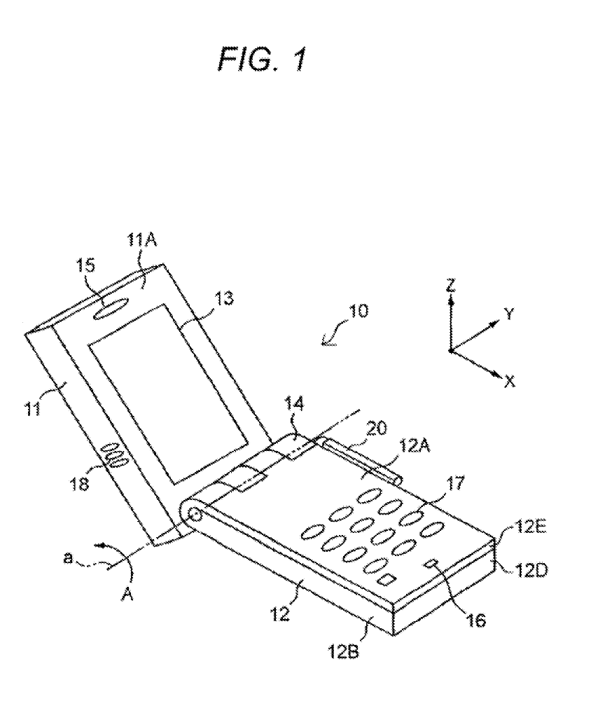

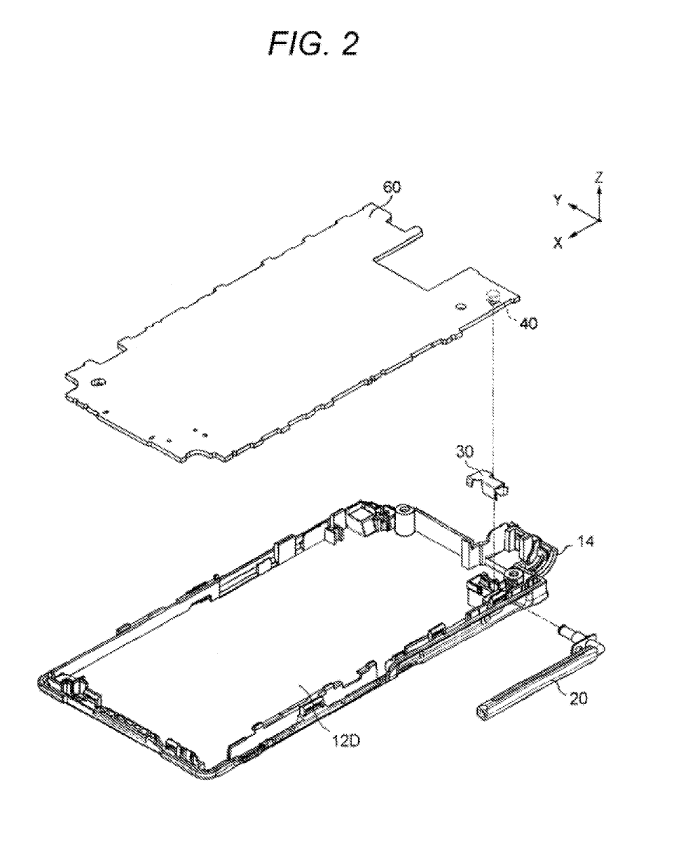

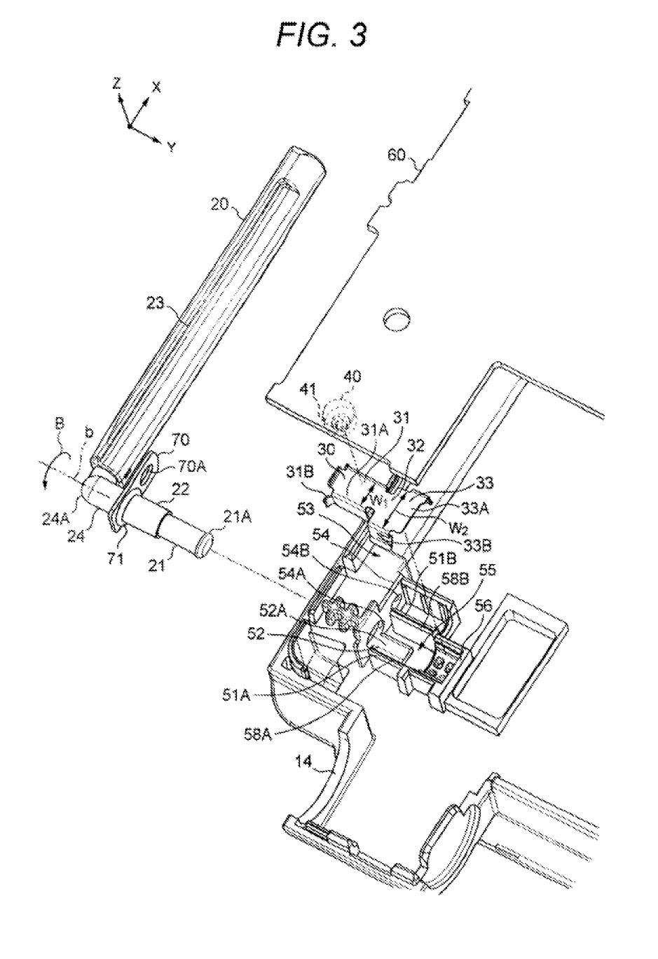

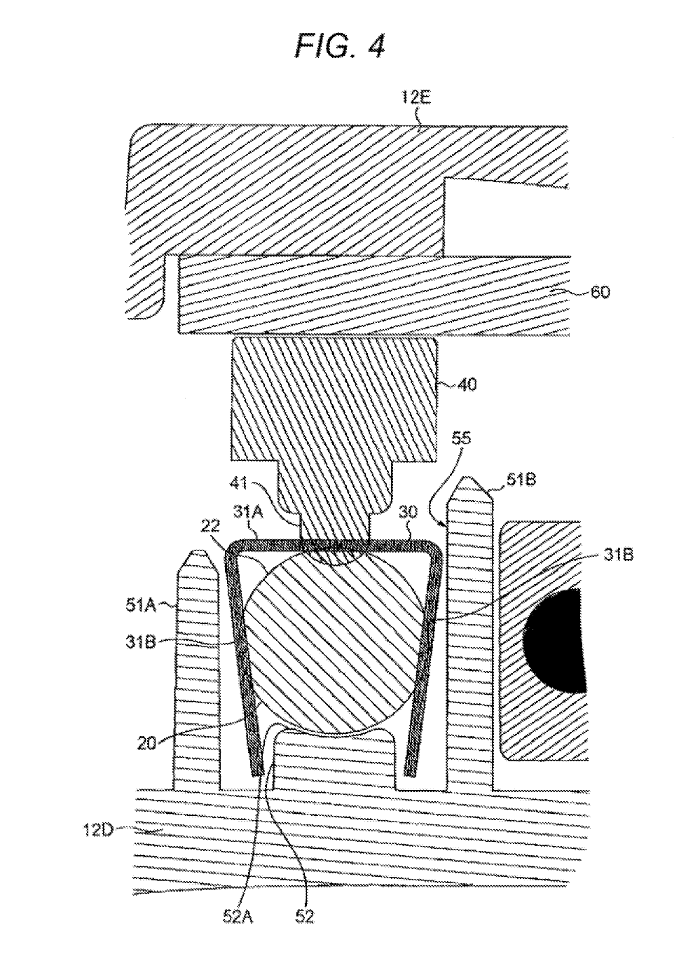

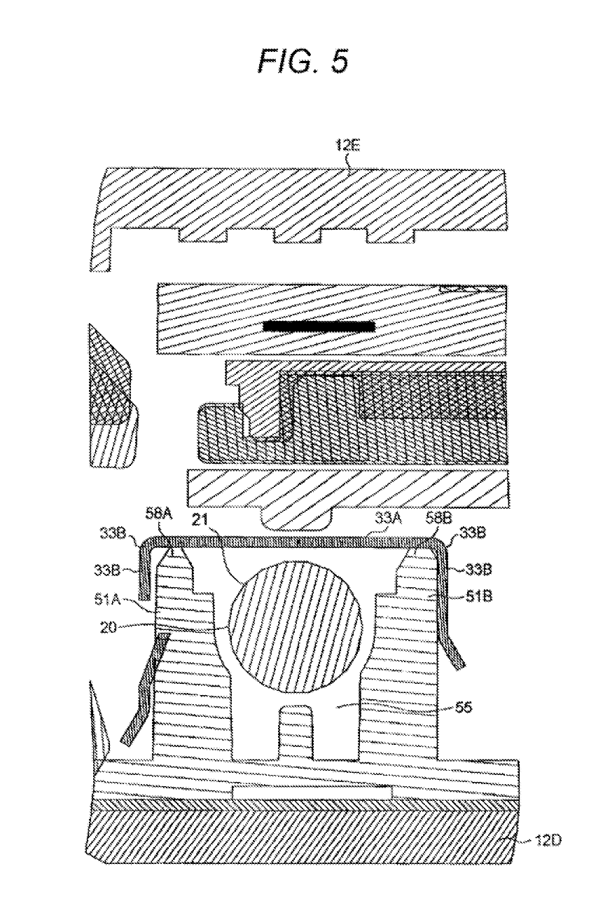

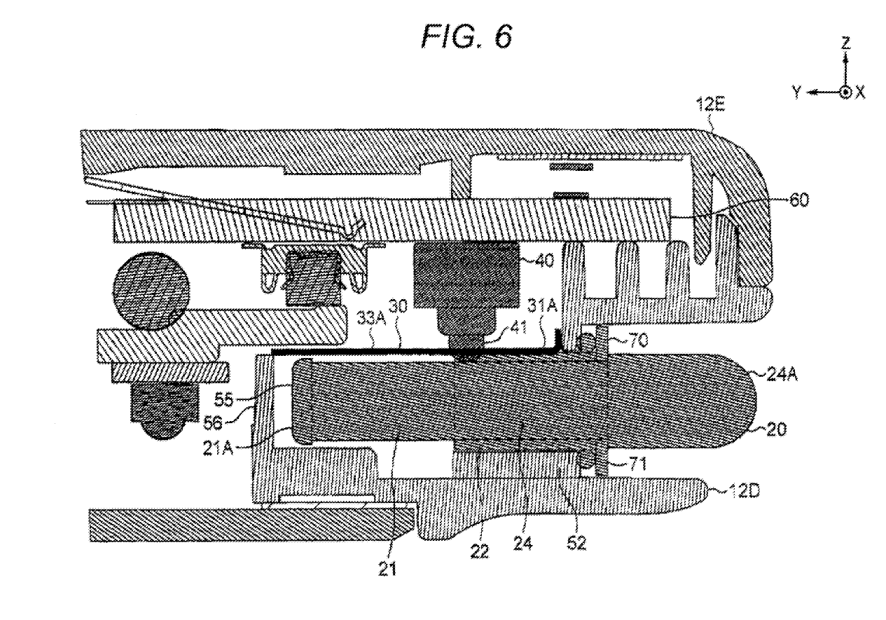

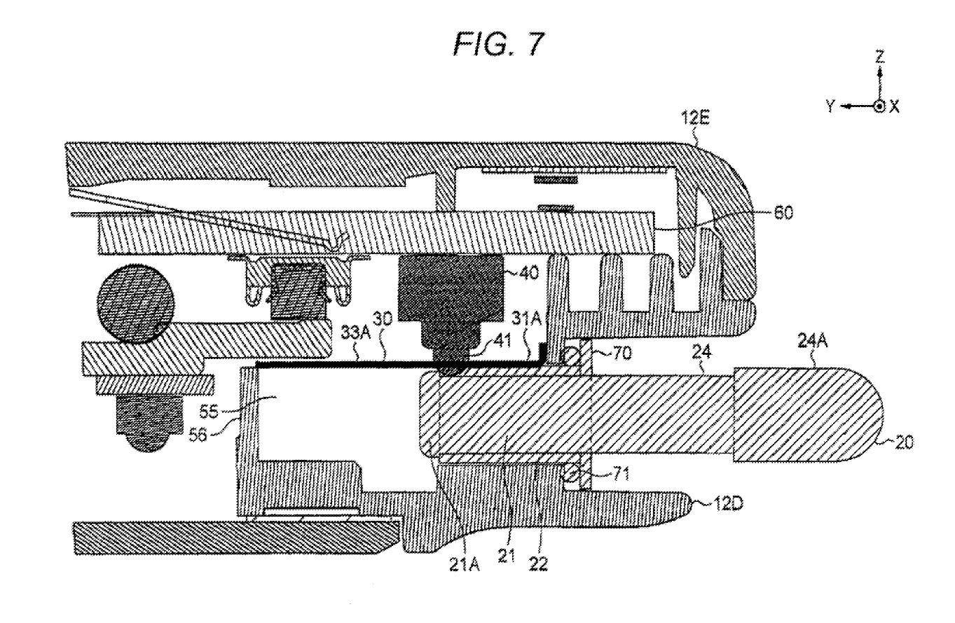

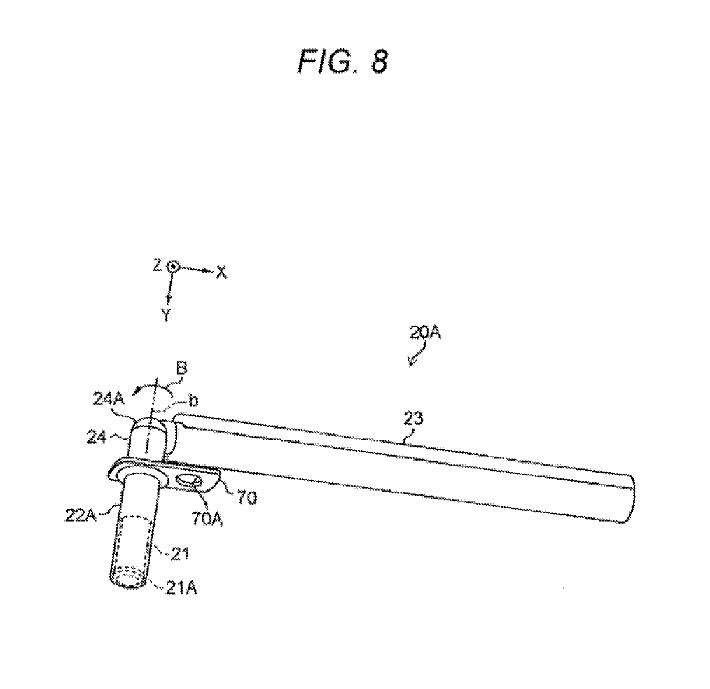

### BRIEF DESCRIPTION OF DRAWINGS

[FIG. 1] FIG. 1 is a perspective view of a cellular phone 10 according to an embodiment.

[FIG. 2] FIG. 2 is a diagram illustrating parts configuring an antenna feed line in the cellular phone 10.

[FIG. 3] FIG. 3 is a diagram illustrating an antenna loaded portion in the cellular phone 10.

[FIG. 4] FIG. 4 is a diagram (1) illustrating a positional relationship of the parts configuring the antenna feed line in the cellular phone 10.

[FIG. 5] FIG. 5 is a diagram (2) illustrating the positional relationship of the parts configuring the antenna feed line in the cellular phone 10.

[FIG. 6] FIG. 6 is a cross-sectional view illustrating the antenna mounted portion of the cellular phone 10 when accommodating the antenna.

[FIG. 7] FIG. 7 is a cross-sectional view illustrating the antenna mounted portion of the cellular phone 10 when extracting the antenna.

[FIG. 8] FIG. 8 is a perspective view of a waterproof antenna 20A.

### DESCRIPTION OF EMBODIMENTS

Hereinafter, an embodiment of the present invention will be described with reference to the drawings. In the respective drawings, an X-axis, a Y-axis, and a Z-axis are axes that are normal to each other and represent orthogonal coordinates, and the same axes in the respective drawings represent identical directions.

### Embodiment

A configuration of a cellular phone 10 according to this embodiment will be described with reference to FIG. 1. FIG. 1 is a perspective view of a cellular phone 10 according to this embodiment. FIG. 1 is a perspective view of the cellular phone 10 according to this embodiment. As illustrated in FIG. 1, the cellular phone 10 according to this embodiment includes, as a rough configuration, an upper housing 11 (second housing) of a substantially box shape, a lower housing 12 (first housing) of a substantially box shape, and a coupling part 14 that openably and closably couples the upper and lower housings 11 and 12 together. With the rotating operation of the coupling part 14, the cellular phone 10 is coupled to be openable and closable in a direction of an arrow A (a first rotation direction) about an axial center a.

During carrying, the cellular phone 10 is used in a superposed state (closed state or close state) where the upper housing 11 and the lower housing 12 configuring the cellular phone 10 are superposed on each other. For example, during calling, when characters, figures, or phone numbers are input, the cellular phone 10 is used in a first open state (first open state or vertically opened state) where the upper housing 11 is rotated about the axial center a in the direction of the arrow A (or first rotating direction) relative to the lower housing 12, from the close state.

The upper housing 11 includes a display part 13, a receiver 15, and a speaker 18. The display part 13 is disposed on a main surface 11A side of the upper housing 11.

The coupling part 14 rotatably couples the upper housing 11 and the lower housing 12 with each other.

The lower housing 12 includes a transmitter (microphone) 16 and an operating part 17. The microphone 16 is disposed on a main surface 12A of the lower housing 12. The microphone 16 is configured to be opposed to and covered with the upper housing 11 when the cellular phone 10 is in the close state, and to be exposed when the cellular phone 10 is in the first open state. During calling, the microphone 16 transmits a user's voice to a communication partner.

Also, the lower housing 12 includes a lower housing main body 12D, and a lower housing cover 12E that covers the lower housing main body 12D from a thickness direction of the housing. The interior of the lower housing 12 is equipped with a printed circuit board 60 on which electric parts for controlling the respective parts of the upper housing 11 and the lower housing 12 are mounted.

The operating part 17 is arranged on the main surface 12A of the lower housing 12. For the sake of inputting phone numbers or characters, figures, characters, and symbols are printed on the operating part 17. The operating part 17 includes a plurality of operation buttons that enables call receiving or call ending, control of a volume output from the receiver 15 or the speaker 18, changeover to a manner mode, and selection and decision on a menu screen.

On one side surface of the lower housing 12 in a longitudinal direction (X-axial direction in the figure) thereof is disposed a whip antenna 20 (hereinafter called “antenna 20”) that extends along a lateral direction (Y-axial direction in the figure) of the lower housing 12, and further extends along a longitudinal direction (X-axial direction in the figure) of the lower housing 12, from a vicinity of the coupling part 14. The antenna 20 is fed from the printed circuit board 60 disposed within the lower housing 12, which will be described later, through a given feed line.

Subsequently, a description will be given of a configuration in which the feed line extending from the printed circuit board 60 to the antenna 20 is formed with reference to FIGS. 2 and 3. FIG. 2 is a diagram illustrating members configuring the antenna feed line to the antenna 20 in the cellular phone 10. FIG. 3 is a diagram illustrating an antenna loaded portion in the cellular phone 10. As illustrated in FIG. 2, the members configuring the feed line extending from the printed circuit board 60 of the cellular phone 10 to the antenna 20 include a metal plate 30 (corresponding to electrically conductive plate member), and a probe pin 40 (corresponding to electrically conductive spring member).

As illustrated in FIG. 2, on an end of the printed circuit board 60 in the vicinity of the coupling part 14, the probe pin 40 is disposed along the thickness direction (Z-axial direction in the figure) of the housing toward the lower housing main body 12D.

The probe pin 40 is pressed against the metal plate 30 positioned below along the thickness direction (Z-axial direction in the figure) of the housing due to an urging force of an urging member internally disposed. Also, the metal plate 30 is pressed against a part of the antenna 20 accommodated in the lower housing main body 12D due to an urging force of the probe pin 40.

The antenna 20 is accommodated in the end of the lower housing main body 12D in the vicinity of the coupling part 14.

As illustrated in FIG. 3, the antenna 20 includes an antenna base 24 that extends from a fitting plate 70 along the lateral direction (Y-axial direction in the figure) of the housing, an antenna main body 23 that extends from the antenna base 24 along the longitudinal direction (X-axial direction in the figure) of the housing, a cylindrical antenna retention part 22 that extends from the fitting plate 70 extending along the longitudinal direction (X-axial direction in the figure) of the housing, to the interior of the housing along the lateral direction (Y-axial direction in the figure) of the housing on an opposite side of the antenna base 24 across the fitting plate 70, and a slide part 21 that is continuous with the antenna base 24 within the antenna retention part 22, and slidable within the antenna retention part 22 along the lateral direction (Y-axial direction in the figure) of the housing.

The fitting plate 70 is provided with a screw hole part 70A adjacent to a fitting position of the antenna base 24 and the antenna retention part 22. The screw hole part 70A and a screw hole part 54B of a front rib 54 are fixed by a screw. For that reason, the fitting plate 70 is fixed to the front rib 54. Also, a portion of the fitting plate 70 to which the antenna retention part 22 is fitted is provided with an O-ring 71 along a periphery of the antenna retention part 22.

The antenna base 24 extends from the fitting plate 70 toward an external of the housing along the lateral direction (Y-axial direction in the figure) of the housing. The antenna base 24 rotatably holds the antenna main body 23 about an axial center b in a direction of an arrow B in the figure. The antenna base 24 is provided with a large-diameter part 24A on a portion extended from the antenna main body 23. When the antenna base 24 and the antenna main body 23 are accommodated in a second accommodation part 53, the large-diameter part 24A contacts the fitting plate 70, thereby preventing the antenna 20 from further getting into the housing.

The antenna main body 23 extends from the antenna base 24 along the longitudinal direction (X-axial direction in the figure) of the housing by a given distance. The antenna main body 23 rotates about the axial center b in the direction of the arrow B in the figure relative to the antenna base 24.

The antenna main body 23 and the antenna base 24 are accommodated within the second accommodation part 53 disposed in the lower housing main body 12D. As the occasions demand, the antenna main body 23 and the antenna base 24 is extracted from the second accommodation part 53 toward the exterior of the housing, and the antenna main body 23 can be rotated about the axial center b in the direction of the arrow B.

The cylindrical antenna retention part 22 is inserted into an opening 54A of the front rib 54 together with the slide part 21, and accommodated into a first accommodation part 55 of the lower housing main body 12D which will be described later. Also, the antenna retention part 22 is supported from below by a lower rib 52 disposed on a bottom surface of the lower housing main body 12D within the first accommodation part 55, which will be described later along a thickness direction (Z-axial direction in the figure) of the housing.

The slide part 21 is slidable within a cylinder of the antenna retention part 22 along the lateral direction (Y-axial direction in the figure) of the housing. With the sliding operation of the slide part 21, the antenna base 24 continuous with the slide part 21 also slides together with the slide part 21 along the lateral direction (Y-axial direction in the figure) of the housing. For that reason, the antenna base 24 and the antenna main body 23 are exposed to the external of the housing when being extracted from the second accommodation part 53 of the lower housing main body 12D. The antenna base 24 and the antenna main body 23, which are exposed to the external, can be accommodated in the second accommodation part 53 of the lower housing main body 12D when being pulled into the second accommodation part 53.

Also, a tip of the slide part 21 is provided with a large-diameter part 21A having a diameter slightly larger than that of the slide part 21. When the antenna base 24 and the antenna main body 23 are extracted from the second accommodation part 53 of the lower housing main body 12D, the large-diameter part 21A contacts the antenna retention part 22 so that the antenna 20 is not further extracted.

As illustrated in FIG. 3, on the end of the lower housing main body 12D in the vicinity of the coupling part 14 is provided with the first accommodation part 55 and the second accommodation part 53, which accommodate the antenna 20 therein. The first accommodation part 55 is surrounded from four directions by the front rib 54 erected upward from the bottom surface of the lower housing main body 12D along the thickness direction (Z-axial direction in the figure) of the housing, a pair of side ribs 51A, 51B, and a rear rib 56. The slide part 21 of the antenna 20 and the retention part 22 are accommodated in the first accommodation part 55.

As illustrated in FIG. 33, on the bottom surface of the first accommodation part 55 is disposed the lower rib 52 that erects upward from that bottom surface along the thickness direction (Z-axial direction in the figure) of the housing, is continuous with the front rib 54 from below of the opening 54A of the front rib 54, and extended along the lateral direction (Y-axial direction in the figure) of the housing by a given distance. A top surface 52A of the lower rib 52 has a curved surface along a cylindrical shape of the retention part 22 of the antenna 20. For that reason, the lower rib 52 contacts the retention part 22 of the antenna 20 on the top surface 52A thereof, and supports the retention part 22 of the antenna 20.

As illustrated in FIG. 3, the front rib 54 is formed of a plate-like member that erects upward from the bottom surface of the lower housing main body 12D along the thickness direction (Z-axial direction in the figure) of the housing. The front rib 54 is integrally molded with the lower housing main body 12D. Also, the front rib 54 includes the opening 54A through which the slide part 21 and the retention part 22 of the antenna 20 are inserted, and the screw hole part 54B adjacent to the opening 54A along the longitudinal direction (X-axial direction in the figure) of the housing. The screw hole part 54B is fastened by a screw inserted into the screw hole part 70A provided in the fitting plate 70 to fix the antenna 20 to the lower housing main body 12D.

As illustrated in FIG. 3, one side rib 51A of the pair of side ribs 51A and 51B extends from a portion slightly distant from one end of the front rib 54 to one end of the rear rib 56 along the lateral direction (Y-axial direction in the figure) of the housing. The other side rib 51B extends from a portion slightly distant from between the opening 54A of the front rib 54 and the screw hole part 54B to the other end of the rear rib 56 along the lateral direction (Y-axial direction in the figure) of the housing. Top surfaces 58A and 58B of the pair of side ribs 51A and 51B, which are opposed to the metal plate 30, are flat for installation of the metal plate 30 which will be described later.

The rear rib 56 extends along the longitudinal direction (X-axial direction in the figure) of the housing, and both ends of the rear rib 56 are continuous with ends of the pair of side ribs 51A and 51B. As described above, the first accommodation part 55 is configured by a part of the front rib 54 having the opening 54A, the pair of side ribs 51A, 51B, and the rear rib 56. The first accommodation part 55 accommodates the retention part 22 and the slide part 21 of the antenna 20 therein.

As illustrated in FIG. 3, the metal plate 30 is installed on the top surfaces 58A and 58B of the pair of side ribs 51A and 51B from above along the thickness direction (Z-axial direction in the figure) of the housing. The metal plate 30 is formed by bending opposite sides of a plate-like metal member so that a cross section of the metal plate 30 is substantially U-shaped. Further, a part of the metal plate 30 is notched during bending to form a narrow part 31, and a wide part 33 continuous with the narrow part 31 through a notch part 32.

The narrow part 31 includes a flat part 31A having a width W1, and a pair of side parts 31B that is continuous with the flat part 31A, and extends downward along the thickness direction (Z-axial direction in the figure) of the housing. The narrow part 31 covers the slide part 21 and the retention part 22 of the antenna 20 inserted from the opening 54A within the first accommodation part 55 from above along the thickness direction (Z-axial direction in the figure) of the housing. The surfaces of the flat part 31A which are opposed to each other along the thickness direction (Z-axial direction in the figure) of the housing are flat.

Likewise, the wide part 33 includes a flat part 33A having a width W2 (>width W1), and a pair of side surfaces 33B that is continuous with the flat part 33A, and extends downward along the thickness direction (Z-axial direction in the figure) of the housing. Different from the narrow part 31, the wide part 33 covers the pair of side ribs 51A and 51B from the outside of the first accommodation part 55.

As illustrated in FIG. 3, the probe pin 40 is disposed on the printed circuit board 60 at a position opposed to the flat part 31A of the narrow part 31 or the flat part 33A of the wide part 33 in the metal plate 30. Also, a tip 41 of the probe pin 40 is pressed against the flat part 31A of the narrow part 31 and the flat part 33A of the wide part 33 in the metal plate 30 by urging means disposed therein. For that reason, the probe pin 40 is electrically connected to the metal plate 30. Further, the probe pin 40 is electrically connected to the antenna 20 through the metal plate 30 pressed against the retention part 22 by the narrow part 31. For that reason, the probe pin 40 and the metal plate 30 form a feed line extending from the printed circuit board 60 to the antenna 20.

Now, a description will be given of a positional relationship of the antenna 20, the metal plate 30, the probe pin 40, and the printed circuit board 60 within the first accommodation part 55 with reference to FIGS. 4 and 5. FIG. 4 is a diagram (1) illustrating a positional relationship of the parts configuring the antenna feed line of the cellular phone 10. FIG. 5 is a diagram (2) illustrating the positional relationship of the parts configuring the antenna feed line of the cellular phone 10.

FIG. 4 illustrates a cross section having the retention part 22 of the antenna 20 included in the first accommodation part 55 of the lower housing main body 12D. As illustrated in FIG. 4, the retention part 22 of the antenna 20 is accommodated within the first accommodation part 55, and supported from below by the lower rib 52 in the thickness direction (Z-axial direction in the figure) of the housing. Also, because the top surface 52A of the lower rib 52 which contacts the retention part 22 has the curved surface along the cylindrical shape of the retention part 22 of the antenna 20, the retention part 22 of the antenna 20 can be easily positioned within the first accommodation part 55 during assembling.

Also, as illustrated in FIG. 4, within the first accommodation part 55, the pair of side parts 31 B is abutted against the retention part 22 of the antenna 20 from the sides, and the flat part 31A is pressed against the retention part 22 of the antenna 20 from above. For that reason, the retention part 22 of the antenna 20 is more surely retained by the metal plate 30. Accordingly, the retention part 22 of the antenna 20 can surely contact the metal plate 30. Also, even if the metal plate 30 is inclined and displaced from a regular position during assembling, the retention part 22 can contact the metal plate 30 by any one of the side parts 31B and the flat part 31A. Further, since the metal plate 30 is supported by the pair of side ribs 51A and 51B from the sides, the metal plate 30 can be easily positioned within the first accommodation part 55.

FIG. 5 illustrates a cross section having the slide part 21 of the antenna 20 included in the first accommodation part 55 of the lower housing main body 12D during accommodating the antenna. As illustrated in FIG. 5, within the first accommodation part 55, the slide part 21 of the antenna 20 is located below the wide part 33 of the metal plate 30 in the thickness direction (Z-axial direction in the figure) of the housing, and does not contact the metal plate 30.

Also, since a face of the flat part 33A of the metal plate 30 which is opposed to the pair of side ribs 51A and 51B is flat, the metal plate 30 can be located on the flat top surfaces 58A and 58B of the pair of side ribs 51A and 51B. Also, the pair of side surfaces 33B of the metal plate 30 grasps the pair of side ribs 51A and 51B so as to cover the pair of side ribs 51A and 51B from the external of the first accommodation part 55. For that reason, the metal plate 30 is surely fixed to the pair of side ribs 51A and 51B by the wide part 33. Accordingly, the tip 41 of the probe pin 40 is surely pressed against the metal plate 30, and the metal plate 30 can contact the probe pin 40 by the wide part 33.

Subsequently, a description will be given of the antenna feed line when accommodating the antenna and extracting the antenna. FIG. 6 is a cross-sectional view illustrating the antenna mounted portion of the cellular phone 10 when accommodating the antenna. FIG. 7 is a cross-sectional view illustrating the antenna mounted portion of the cellular phone 10 when extracting the antenna.

As illustrated in FIG. 6, the antenna base 24 except for the large-diameter part 24A is accommodated within the retention part 22 whereas the slide part 21 is extracted from the interior of the retention part 22 into the first accommodation part 55. Also, the tip 41 of the probe pin 40 protruded downward from the printed circuit board 60 along the thickness direction (Z-axial direction in the figure) of the housing is pressed against the flat part 31A of the narrow part 31 of the metal plate 30. Further, the flat part 31A of the narrow part 31 of the metal plate 30 is abutted against the cylindrical retention part 22 located below along the thickness direction (Z-axial direction in the figure) of the housing. For that reason, the antenna 20 is fed from the printed circuit board 60 through the probe pin 40, the narrow part 31, and the retention part 22.

As illustrated in FIG. 7, the slide part 21 is pulled into the retention part 22 while the antenna base 24 except for the large-diameter part 24A is extracted from the interior of the retention part 22 toward the exterior of the housing. Also, the tip 41 of the probe pin 40 protruded downward from the printed circuit board 60 along the thickness direction (Z-axial direction in the figure) of the housing is pressed against the flat part 31A of the narrow part 31 by an urging force of the urging means disposed within the probe pin 40. Further, the flat part 31A of the narrow part 31 is abutted against the cylindrical retention part 22 located below along the thickness direction (Z-axial direction in the figure) of the housing. For that reason, the antenna 20 is fed from the printed circuit board 60 through the probe pin 40, the narrow part 31 of the metal plate 30, and the retention part 22.

In this example, as illustrated in FIGS. 6 and 7, the flat part 31A of the narrow part 31 of the metal plate 30 is continuous with the flat part 33A of the wide part 33 along the lateral direction (Y-axial direction in the figure) of the housing. For that reason, even if the position of the metal plate 30 is displaced from the regular position when assembling, the probe pin 40 projected from the printed circuit board 60 is pressed against the flat part 33A of the wide part 33 which is continuous with the flat part 31A of the narrow part 31. That is, even if the position of the metal plate 30 is displaced from the regular position when assembling, the probe pin 40 is pressed against any one of the flat parts 31A and 33A of the narrow part 31 and the wide part 33. In other words, the surface of the metal plate 30 against which the probe pin 40 is pressed can be enlarged up to not only the flat part 31A of the narrow part 31 but also the flat part 33A of the wide part 33.

As described above, in the antenna 20 according to this embodiment, the surface of the metal plate 30 against which the probe pin 40, which is a part of the feed line to the antenna 20, is pressed is enlarged up to not only the flat part 31A of the narrow part 31 but also the flat part 33A of the wide part 33. Therefore, even if the metal plate 30 is not assembled with high precision in advance, the probe pin 40 surely contacts with the metal plate 30.

Also, in the cellular phone 10 according to this embodiment, the pair of side parts 31B of the metal plate 30 which is a part of the feed line to the antenna 20 is abutted against the retention part 22 of the antenna 20 from the sides within the first accommodation part 55, and the flat part 31A is pressed against the retention part 22 of the antenna 20 from above. Therefore, even if the metal plate 30 is not assembled with the antenna 20 with high precision, the metal plate 30 surely contacts the antenna 20.

Further, in the cellular phone 10 according to this embodiment, there is no need to require the high precision of the parts (for example, metal plate 30 and probe pin 40) configuring the feed line to the antenna 20. For that reason, an increase in the manufacturing costs of the parts configuring the feed line to the antenna 20 and the cellular phone 10 per se can be avoided.

### (Waterproof Antenna 20A)

In this example, in the cellular phone 10 according to this embodiment, the slide part 21 and the antenna base 24 of the antenna 20 slide within the cylinder of the retention part 22. For that reason, solution (for example, water) enters the first accommodation part 55 from the external of the housing through a slight gap formed between the retention part 22 and the slide part 21 within the cylinder of the retention part 22. When the solution further reaches the printed circuit board 60, there is a possibility that various electronic parts mounted on the printed circuit board 60 are short-circuited.

Under the circumstances, as illustrated in FIG. 8, for the purpose of protecting the various electronic parts mounted on the printed circuit board 60, a waterproof antenna 20A configured so that solution does not enter the first accommodation part 55 can be used instead of the antenna 20 in the cellular phone 10 according to this embodiment.

A configuration of the waterproof antenna 20A will be described with reference to FIG. 8. A difference of the waterproof antenna 20A illustrated in FIG. 8 from the antenna 20 illustrated in FIG. 3 resides in that the cylindrical waterproof antenna 20A is in the form of a vessel that covers the slide part 21. The other configurations are identical with those of the antenna 20, and the same configurations are denoted by identical symbols, and their detailed description will be omitted.

As illustrated in FIG. 8, a retention part 22A of the waterproof antenna 20A is in the form of the vessel that completely covers the slide part 21 that is pulled into the first accommodation part 55 from the fitting plate 70 along the lateral direction (Y-axial direction in the figure) of the housing when accommodating the antenna. For that reason, even if solution enters the interior of the cylinder of the retention part 22A from the external of the housing through the slight gap formed between the retention part 22A and the slide part 21 within the cylinder of the retention part 22A, the solution does not enter the first accommodation part 55 because the retention part 22A is in the form of the vessel. For that reason, the respective electronic parts mounted on the printed circuit board 60 disposed within the housing is protected without being short-circuited by the solution.

As described above, in the cellular phone 10 according to this embodiment, with the use of the waterproof antenna 20A configured so that the solution does not enter the first accommodation part 55 instead of the antenna 20, the various electronic parts mounted on the printed circuit board 60 can be protected.

Also, in the cellular phone 10 according to this embodiment, even with the use of the waterproof antenna 20A configured so that the solution does not enter the first accommodation part 55 instead of the antenna 20, the surface of the metal plate 30 against which the probe pin 40, which is a part of the feed line to the waterproof antenna 20A, is urged and abutted is enlarged up to the flat part 31A of the narrow part 31 but also the flat part 33A of the wide part 33 as with the antenna 20. Therefore, even if the metal plate 30 is not assembled with the printed circuit board 60 with high precision in advance, the probe pin 40 can ensure the contact with the metal plate 30.

Further, in the cellular phone 10 according to this embodiment, even with the use of the waterproof antenna 20A configured so that the solution does not enter the first accommodation part 55 instead of the antenna 20A, the pair of side parts 31 B of the metal plate 30 which is a part of the feed line to the antenna 20A is abutted against the retention part 22 of the antenna 20A from the sides within the first accommodation part 55, and the flat part 31A is urged and pressed against the retention part 22 of the antenna 20A from above. Therefore, even if the metal plate 30 is not assembled with the antenna 20A with high precision, the metal plate 30 surely contacts the antenna 20A.

Furthermore, in the cellular phone 10 according to this embodiment, even with the use of the waterproof antenna 20A configured so that the solution does not enter the first accommodation part 55 instead of the antenna 20, there is no need to require the high precision of the parts (for example, metal plate 30 and probe pin 40) configuring the feed line to the antenna 20A as with the antenna 20. For that reason, an increase in the manufacturing costs of the parts configuring the feed line to the antenna 20A and the cellular phone 10 per se can be avoided.

The present invention has been described in detail with reference to the specific embodiments, and can be variously changed or modified without departing from the spirit and scope of the present invention as would be apparent to those skilled in the art.

### INDUSTRIAL APPLICABILITY

The portable terminal according to the present invention has the advantage that the electrically conductive spring member surely forms the contact with the electrically conductive plate member, and is useful as a cellular phone.

### REFERENCE SIGNS LIST

10, cellular phone
20, whip antenna
21, slide part
22, retention part
30, metal plate (electrically conductive plate member)
40, probe pin (electrically conductive spring member)
51A, 51B, a pair of side ribs
52, lower rib
54A, insertion through-hole
60, printed circuit board

1. A portable terminal comprising:
a whip antenna;
a housing that has an insertion hole through which the whip antenna is inserted;
a printed circuit board that is disposed within the housing;
an electrically conductive plate member that is abutted against the whip antenna within the housing; and
an electrically conductive spring member that is arranged between the printed circuit board and the electrically conductive plate member,
wherein the whip antenna includes a slide part that is slidable within the housing, and a retention part that slidably retains the slide part;
wherein a pair of first ribs is provided along a slide direction of the slide part so as to retain the retention part of the whip antenna therebetween within the housing;
wherein a second rib is provided between the pair of first ribs on an opposite side of the electrically conductive spring member across the whip antenna, and supports the retention part; and
wherein the electrically conductive plate member is positioned between the whip antenna and the electrically conductive spring member within the housing, and is pressed against the whip antenna at a second surface of the electrically conductive plate member opposite to a first surface of the electrically conductive plate member against which the electrically conductive spring member is pressed in a thickness direction of the housing.

2. The portable terminal according to claim 1,
wherein the pair of first ribs supports the electrically conductive plate member by bringing a part of a surface facing the electrically conductive plate member into contact with the first surface of the electrically conductive plate member.

3. The portable terminal according to claim 2, wherein a surface of the second rib for supporting the retention part is formed in a curved surface.

4. The portable terminal according to claim 1, wherein the electrically conductive plate member has a wide part which brings into contact with the pair of first ribs and a narrow part which is smaller in width than the wide part, at a surface of the electrically conductive plate member with which the electrically conductive spring member is contacted.

5. The portable terminal according to claim 1, wherein the electrically conductive plate member is formed in a U shape in a cross section thereof, and is contained between the pair of the first ribs while contacting the pair of the first ribs.
